(19) United States
(12) Patent Application Publication
(10) Pub. No.: US 2023/0345296 A1
(43) Pub. Date: Oct. 26, 2023

(54) NETWORK DEVICE, CONTROL CIRCUIT, STORAGE MEDIUM, AND NETWORK CONFIGURATION METHOD

(71) Applicant: Mitsubishi Electric Corporation, Tokyo (JP)

(72) Inventors: Yuji MIYAKE, Tokyo (JP); Masao OGA, Tokyo (JP)

(73) Assignee: Mitsubishi Electric Corporation, Tokyo (JP)

(21) Appl. No.: 18/216,239

(22) Filed: Jun. 29, 2023

Related U.S. Application Data
(63) Continuation of application No. PCT/JP2021/012354, filed on Mar. 24, 2021.

(51) Int. Cl. H04W 28/02; H04W 24/08; H04W 76/10

(52) U.S. Cl. CPC H04W 28/0268; H04W 24/08; H04W 76/10

(57) ABSTRACT

A network device includes: a QoS management unit that measures a quality of service when user data transfer is performed between wireless terminal devices via user transfer function units of a core system device that controls a network; a PDU session management unit that acquires information of sessions from a session management function unit of the core system device, the sessions having been established for user data transfer between the wireless terminal devices; a PDU session setting unit that determines whether or not to establish new sessions, based on the quality of service; a user-data transfer destination management unit that manages a group that is based on the new sessions and transfer destinations of user data in the new sessions; and a user-data transfer destination setting unit that sets, to the session management function unit, the transfer destinations of user data in the new sessions.

### CROSS-REFERENCE TO RELATED APPLICATION

This application is a continuation application of International Application PCT/JP2021/012354, filed on Mar. 24, 2021, and designating the U.S., the entire contents of which are incorporated herein by reference.

### BACKGROUND OF THE INVENTION

### 1. Field. of the Invention

The present disclosure relates to a network device, a control circuit, a storage medium, and a network configuration method, which are intended to control communication between wireless terminal devices.

### 2. Description of the Related Art

A 5th generation (5G) system standardized by 3rd Generation Partnership Project (3GPP) treats each packet data unit (PDU) session as one group when transferring user data between user equipments (UEs) that are each a wireless terminal device, the PDU session being established between each UE and a User Plane Function (UPF) that is a user transferring function unit in a core network device, via a Radio Access Network (RAN) that is a wireless base station device, and performs return transfer between PDU sessions at the UPF, so as to realize communication between the UEs. The destination of user data return-transferred is managed by a Session Management Function (SMF) that is a session management function unit. In a case where the UEs are distant from each other, the UPF performs return transfer between the PDU sessions established via different RANs, thereby to provide UE-to-UE communication.

In addition, a 5G system is capable of providing time sensitive communication (TSC) that is time sensitive communication between devices deployed on a time sensitive networking (TSN) that is a time sensitive network supporting high-precision time synchronization. In a case where UE-to-UE communication is to be performed in the TSC, it is assumed that the UPF serving as a return point for the PDU session is connected to a TSN translator. When the UPF directly connected to the RAN connected with the UEs is not connected to the TSN translator, a UPF connected to the TSN translator is determined to be a return point for the PDU session. The UPF serving as a return point for the PDU session is referred to as an anchor UPF. The anchor UPF treats, as one group, each PDU session established between each UE and the anchor UPF to provide TSC communication between the UEs. A UPF not connected to a TSN translator operates as an intermediate UPF (I-UPF) to transfer user data transmitted from each UE.

As described above, UE-to-UE communication in TSC is performed with a UPF connected to the TSN translator being used as a return point for the PDU session. However, not all the UPFs are necessarily connected with the TSN translator. A UPF not connected to the TSN translator is supposed to transfer user data to a higher-level UPF connected to the TSN translator. Accordingly, the scale of communication path or paths on the TSN network increases, and so there is assumed a case where a possible situation does not comply with a quality of service (QoS), particularly such as a delay requirement. To address such a problem, Patent Literature 1 discloses a technique to check whether or not the delay requirement is satisfied by means of adding a unique time stamp to a packet during data transfer when communication is performed over multiple UPFs, and to discard a packet at the time of occurrence of a delay amount exceeding the delay requirement.
Patent Literature 1: International Publication No. WO 2020/104017 A

However, the foregoing conventional technique has presented a problem in that many packets will undergo a delay amount exceeding the delay requirement, thereby resulting in frequent occurrence of discard of packets in a case of a network configuration requiring a lot of UPFs through which the anchor UPF connected to the TSN translator is reached. Such network configuration needs to connect many UPFs with the TSN translator to transfer user data for the UE-to-UE communication between lower-level UPFs.

The present disclosure has been made in view of the foregoing circumstances, and an object of the present disclosure is to provide a network device capable of reducing delay in communication between wireless terminal devices while keeping the number of time sensitive network translators small in user data transfer between wireless terminal devices in time sensitive communication.

### SUMMARY OF THE INVENTION

In order to solve the above-mentioned problem and achieve the object, the present disclosure provides a network device comprising: a quality-of-service management circuit to measure a quality of service when user data transfer is performed between wireless terminal devices via user transfer function circuits of a core system device that controls a network; a session management circuit to acquire information of sessions from a session management function circuit of the core system device, the sessions having been established for user data transfer between the wireless terminal devices; a session setting circuit to determine whether or not to establish new sessions, based on the quality of service; a user-data transfer destination management circuit to manage a group that is based on the new sessions and transfer destinations of user data in the new sessions; and a user-data transfer destination setting circuit to set, to the session management function circuit, the transfer destinations of user data in the new sessions.

### BRIEF DESCRIPTION OF THE DRAWINGS

FIG. 1 is a diagram illustrating an example configuration of a 5G system that is a wireless network system according to a present embodiment;

FIG. 2 is a block diagram illustrating an example configuration of a network device according to the present embodiment;

FIG. 3 is a diagram illustrating an example of a network architecture of the 5G system according to the present embodiment;

FIG. 4 is a first diagram illustrating an establishment situation of a PDU session when transfer of user data has occurred between UEs in TSC in the 5G system according to the present embodiment;

FIG. 5 is a flowchart illustrating an operation of the network device included in the 5G system according to the present embodiment;

FIG. 6 is a second diagram illustrating an establishment situation of a PDU session when transfer of user data has occurred between UEs in TSC in the 5G system according to the present embodiment;

FIG. 7 is a diagram illustrating an example configuration of a processing circuit included in the network device according to the present embodiment when the processing circuit is implemented by a processor and a memory; and

FIG. 8 is a diagram illustrating an example of a processing circuit included in the network device according to the present embodiment when the processing circuit is formed by a dedicated hardware set.

### DETAILED DESCRIPTION OF THE PREFERRED EMBODIMENTS

A network device, a control circuit, a storage medium, and a network configuration method according to an embodiment of the present disclosure will be described in detail below with reference to the drawings.

### Embodiment

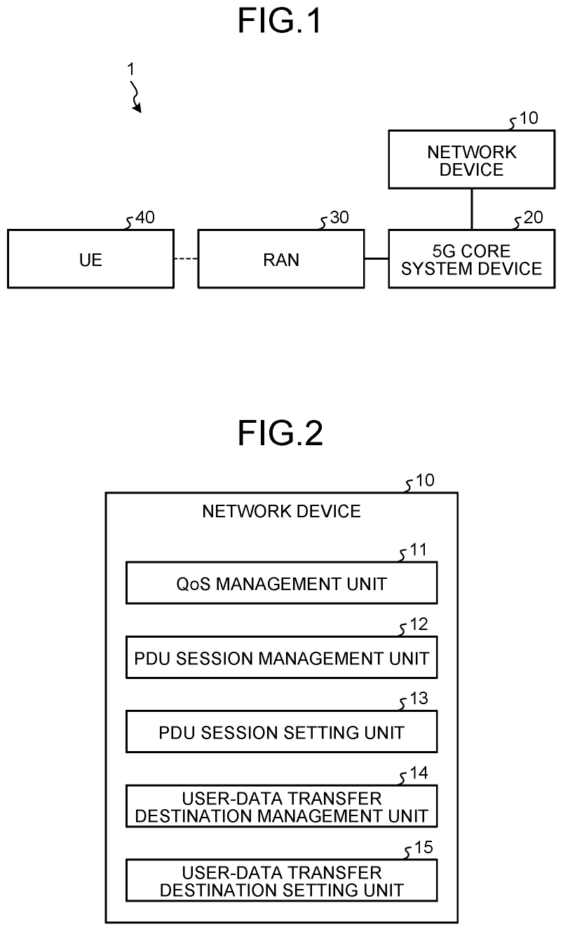

FIG. 1 is a diagram illustrating an example configuration of a 5G system 1 that is a wireless network system according to a present embodiment. The 5G system 1 includes a network device 10, a 5G core system device 20, an RAN 30, and a UE 40. The 5G system 1 is a network in which multiple devices perform communication with each other in a 5G technology. The network device 10 controls transfer of user data performed by the UE 40 in the 5G system 1. The 5G core system device 20 is a device including a UPF, an SMF, and the like described in the above Background section, which refers to a core system device adapted to control communication in the 5G system 1. The RAN 30 is a device corresponding to the wireless base station device described in the above Background section. The UE 40 is a device corresponding to the wireless terminal device described in the above Background section. In the 5G system 1, the network device 10 and the 5G core system device 20 may be configured by different sets of hardware connected to each other via a wired network or the like, or may be configured with programs executed in one and the same hardware set. Note that the 5G system 1 in the example of FIG. 1 is illustrated as including a single RAN 30 and a single UE 40 for simplicity of illustration, but the 5G system 1 in fact includes multiple RANs 30 and multiple UEs 40.

FIG. 2 is a block diagram illustrating an example configuration of the network device 10 according to the present embodiment. The network device 10 includes a QoS management unit or circuit 11, a PDU session management unit or circuit 12, a PDU session setting unit or circuit 13, a user-data transfer destination management unit or circuit 14, and a user-data transfer destination setting unit or circuit 15.

The QoS management unit 11 is a quality-of-service management unit or circuit that measures a QoS that is the quality of service of TSC in a network of the 5G system 1, and manages information of the QoS.

Specifically, the QoS management unit 11 measures a QoS when user data is transferred between the UEs 40 via a UPF (not illustrated in FIG. 1) included in the 5G core system device 20.

The PDU session management unit 12 is a session management unit or circuit that acquires information of PDU sessions established for user data transfer of the UEs 40, from an SMF (not illustrated in FIG. 1) included in the 5G core system device 20, and manages the information of PDU sessions. In the following description, a PDU session may be referred to simply as a session in some cases.

The PDU session setting unit 13 is a session setting unit or circuit that sets a PDU session, and instructs the SMF included in the 5G core system device 20 to establish the PDU session. Specifically, the PDU session setting unit 13 determines whether or not to establish a new session on the basis of the QoS measured by the QoS management unit 11.

The user-data transfer destination management unit 14 manages PDU session group information and information of user-data transfer destinations for communication between the UEs 40. Specifically, the user-data transfer destination management unit 14 manages a group that is based on a new PDU session established according to the instruction of the PDU session setting unit 13, and manages the transfer destinations of the user data in the new PDU session.

The user-data transfer destination setting unit 15 sets a user-data transfer destination based on information having been managed in the user-data transfer destination management unit 14. Specifically, the user-data transfer destination setting unit 15 sets, in the above-mentioned SMF, a transfer destination of the user data in a new PDU session established according to an instruction of the PDU session setting unit 13.

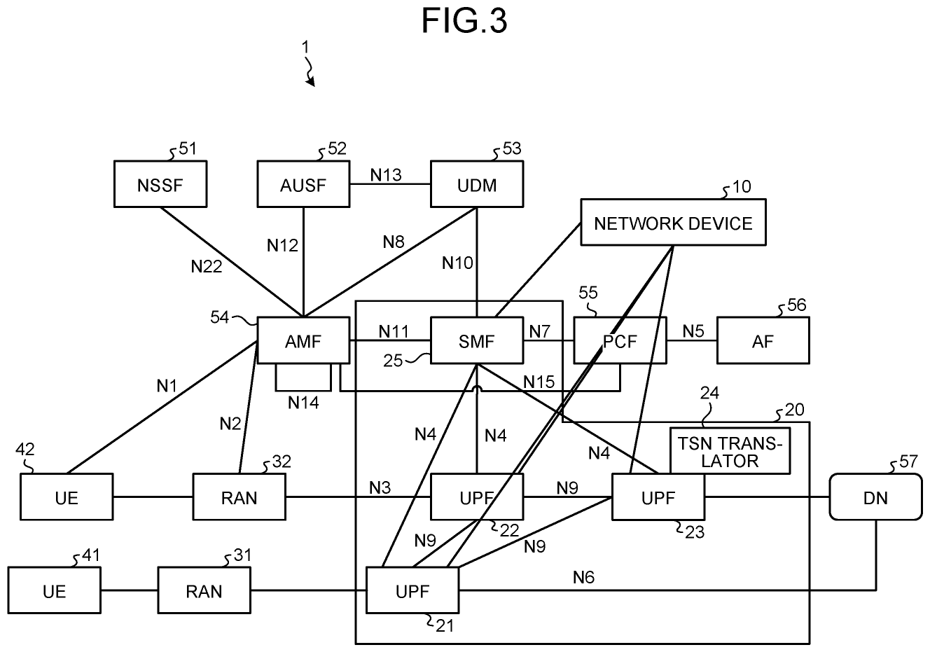

FIG. 3 is a diagram illustrating an example of a network architecture of the 5G system 1 according to the present embodiment. The 5G system 1 includes the network device 10, the 5G core system device 20, RANs 31 and 32, UEs 41 and 42, a network slice selection function (NSSF) 51, an authentication server function (AUSF) 52, a unified data management (UDM) 53, an access and mobility management function (AMF) 54, a policy control function (PCF) 55, an application function (AF) 56, and a data network (DN) 57. As illustrated in FIG. 3, the 5G core system device 20 includes UPFs 21 to 23, a TSN translator 24, and an SMF 25.

The UPFs 21 to 23, the TSN translator 24, and the SMF 25 are devices that corresponds to the UPFs, the TSN translator, and the SMF described above in the Background section, respectively. The RANs 31 and 32 each refer to a device equivalent to the RAN 30 illustrated in FIG. 1. The UEs 41 and 42 each refer to a device equivalent to the UE 40 illustrated in FIG. 1. The NSSF 51 manages the SMF for each of slices of network having different properties. The AUSF 52 is a server for subscriber authentication. The UDM 53 retains information relating to a subscriber. The AMF 54 manages subscriber authentication, terminal location information, and the like. The PCF 55 performs policy control. The AF 56 is an external application server. The DN 57 is external network data.

As illustrated in FIG. 3, the UPFs 21 to 23 are connected to one and the same SMF 25. The SMF 25 manages PDU sessions established by the UPFs 21 to 23. Also as illustrated in FIG. 3, the network device 10 is connected to the UPFs 21 to 23 and to the SMF 25. Herein, connection may be based on a configuration having an external interface or based on a configuration having logical connections in one and the same device. Note that the interfaces denoted by reference symbols such as N1 in FIG. 3 are interfaces defined by the 3GPP. The UPFs 21 to 23 are connected to one another using N9 interface. In the network device 10, only the UPF 23 is connected to the TSN translator 24.

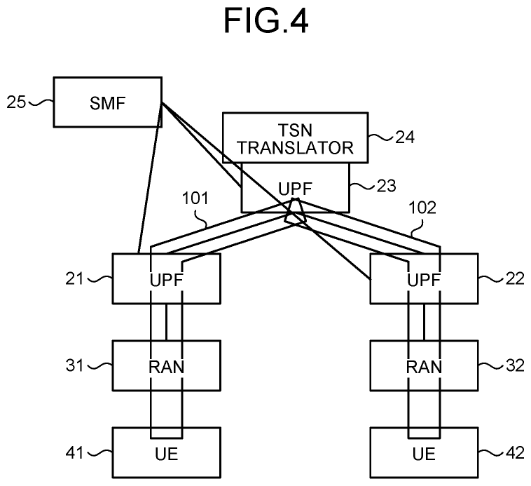

FIG. 4 is a first diagram illustrating a situation of establishment of PDU sessions 101 and 102 when user data transfer has occurred between the UEs 41 and 42 based on TSC in the 5G system 1 according to the present embodiment. In FIG. 4, the PDU session 101 has been established between the UE 41 and the UPF 23 via the RAN 31 and the UPF 21. In addition, the PDU session 102 has been established between the UE 42 and the UPF 23 via the RAN 32 and the UPF 22. The UPF 23 is connected with the TSN translator 24. The SMF 25 manages, as a single group, the PDU sessions 101 and 102 established between the UPF 23, connected with the TSN translator 24 and the UEs 41 and 42. The UEs 41 and 42 transmit and receive user data between the UEs 41 and 42 with using, as a return point, the UPF 23 connected with the TSN translator 24.

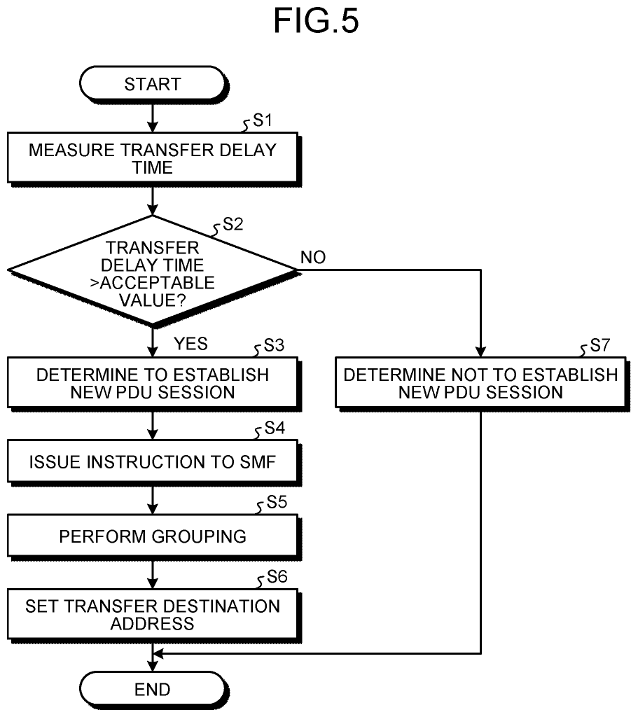

Although FIG. 4 provides a simplified illustration for showing the PDU sessions 101 and 102, the UPFs 21 to 23 and the SMF 25 are connected with the network device 10 as illustrated in FIG. 3. An operation of the network device 10 in a situation of establishment of the PDU sessions 101 and 102 as illustrated in FIG. 4 will next be described. FIG. 5 is a flowchart illustrating an operation of the network device 10 included in the 5G system 1 according to the present embodiment.

In the network device 10, the QoS management unit 11 periodically measures a QoS of TSC. Specifically, the QoS management unit 11 measures transfer delay times of user data flowing through the UPF 21→the UPF 23→the UPF 22 and of user data flowing through the UPF 22→the UPF 23→the UPF 21 (step S1). The QoS management unit 11 notifies the PDU session setting unit 13 of the measured transfer delay times of the user data. Note that the QoS management unit 11 may notify the PDU session setting unit 13 of the measured transfer delay times of the user data in response to a request from the PDU session setting unit 13.

The PDU session setting unit 13 acquires a current situation of establishment of the PDU sessions 101 and 102 from the PDU session management unit 12. Specifically, the PDU session setting unit 13 acquires a situation of establishment of the PDU sessions 101 and 102 as illustrated in FIG. 4 from the PDU session management unit 12. The PDU session setting unit 13 also acquires a transfer delay time of user data from the QoS management unit 11. The PDU session setting unit 13 compares the transfer delay time of user data acquired from the QoS management unit 11 with an acceptable value that has been defined in advance (step S2). The acceptable value may be an amount of delay determined based on a demanded QoS level, or may be a value having a margin with respect to the amount of delay.

When the transfer delay time of user data measured by the QoS management unit 11 is greater than the acceptable value (step S2: Yes), the PDU session setting unit 13 determines to establish new PDU sessions for communication between the UEs 41 and 42 (step S3). The cause of increase of the transfer delay time of user data is the user data passing through many UPFs as described above. Therefore, the PDU session setting unit 13 instructs the SMF 25 to establish new PDU sessions for user data transfer between the UPFs 21 and 22 and the UEs 41 and 42 using an N9 interface between the lower-level UPFs 21 and 22 that are not connected with the TSN translator 24 among the UPFs 21 to 23 (step S4). The SMF 25 establishes new PDU sessions based on the instruction from the PDU session setting unit 13.

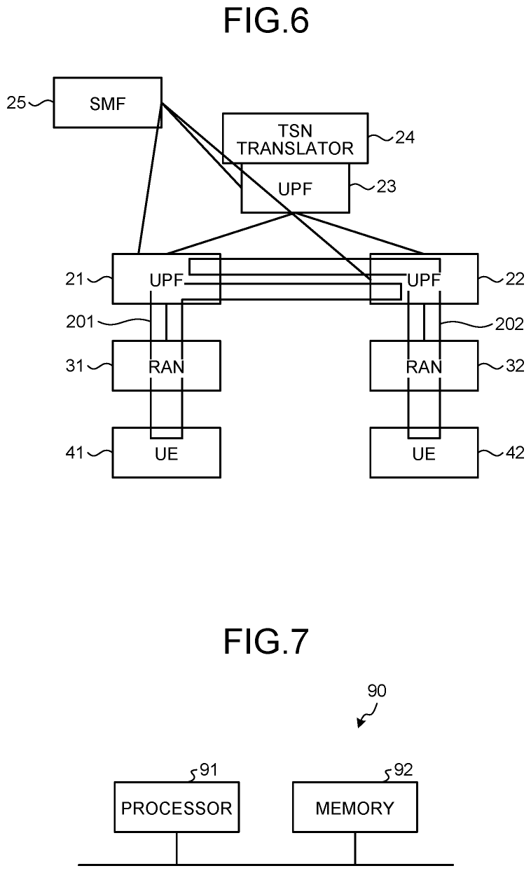

FIG. 6 is a second diagram illustrating a situation of establishment of PDU sessions 201 and 202 when user data transfer has occurred between the UEs 41 and 42 based on TSC in the 5G system 1 according to the present embodiment. The PDU session 201 is a PDU session from the UE 41 through the RAN 31 and the UPF 21 to the UPF 22. The PDU session 202 is a PDU session form the UE 42 through the RAN 32 and the UPF 22 to the UPF 21. Note that although not illustrated in FIG. 6, the PDU sessions 101 and 102 illustrated in FIG. 4 are maintained and used in transmission and reception of TSN control information for TSC. The PDU session setting unit 13 notifies the user-data transfer destination management unit 14 of information about the newly established PDU sessions 201 and 202.

The user-data transfer destination management unit 14 groups the newly established PDU sessions 201 and 202 as the PDU sessions for transmission and reception of the user data between the UEs 41 and 42 (step S5). The user-data transfer destination management unit 14 notifies the user-data transfer destination setting unit 15 of information about the new PDU sessions 201 and 202 obtained by the grouping. The user-data transfer destination setting unit 15 sets, for the SMF 25, transfer destination addresses of the user data in the UPFs 21 and 22 (step S6). The SMF 25 sets the transfer destination addresses of the user data to the UPFs 21 and 22 based on the setting from the user-data transfer destination setting unit 15.

For example, when the user data is to be transmitted from the UE 41 to the UE 42, the UE 41 transmits the user data toward the UPF 22 for the PDU session 201. Based on the setting of the user-data transfer destination setting unit 15, the SMF 25 has configured the UPF 22 to transfer, using the PDU session 202, the transfer destination address of the user data from the UE 41 directed to the UE 42. On that basis, the UPF 22 transfers the user data directed to the UE 42 acquired by the PDU session 201 to the UE 42 using the PDU session 202.

Likewise, when the user data is to be transmitted from the UE 42 to the UE 41, the UE 42 transmits the user data toward the UPF 21 for the PDU session 202. Based on the setting of the user-data transfer destination setting unit 15, the SMF 25 has configured the UPF 21 to transfer, using the PDU session 201, the transfer destination address of the user data from the UE 42 directed to the UE 41. On That basis, the UPF 21 transfers the user data directed to the UE 41 acquired by the PDU session 202 to the UE 41 using the PDU session 201.

As described above, the network device 10 issues an instruction to establish the new PDU sessions 201 and 202 for user data transfer between the UEs 41 and 42, and sets the user-data transfer destinations, thereby making it possible to reduce the number of times of transfer of the UPFs, and to reduce the transfer delay time of the user data in TSC. Note that the UPFs 21 and 22 do not need to recognize the entire transfer path used by the new PDU sessions 201 and 202 and a UPF that has been selected to act as a return point.

When the transfer delay time of user data measured by the QoS management unit 11 is less than or equal to the acceptable value (step S2: No), the PDU session setting unit 13 determines not to establish the new PDU sessions 201 and 202 for communication between the UEs 41 and 42 (step S7), and the operation is terminated. The network device 10 periodically performs the operation of the flowchart illustrated in FIG. 5.

A hardware configuration of the network device 10 will next be described. In the network device 10, the QoS management unit 11, the PDU session management unit 12, the PDU session setting unit 13, the user-data transfer destination management unit 14, and the user-data transfer destination setting unit 15 are implemented by a processing circuit. The processing circuit may be a combination of a processor and a memory, the processor being adapted to execute a program stored in the memory, or may be a dedicated hardware set. The processing circuit is also referred to as a control circuit.

FIG. 7 is a diagram illustrating an example configuration of a processing circuit 90 included in the network device 10 according to the present embodiment in the case where the processing circuit is implemented by a processor 91 and a memory 92. The processing circuit 90 illustrated in FIG. 7 is a control circuit, and includes the processor 91 and the memory 92. In the case where the processing circuit 90 is composed of the processor 91 and the memory 92, each function of the processing circuit 90 is implemented by software, firmware, or a combination of software and firmware. The software or firmware is described in the form of a program, and the program is stored in the memory 92. The processing circuit 90 implements each function by the processor 91 reading out and executing a program stored in the memory 92. That is, the processing circuit 90 includes the memory 92 for storing a program by which processing of the network device 10 is resultantly performed. It can also be said that this program is a program for causing the network device 10 to perform each function to be performed by the processing circuit 90. This program may be provided using a storage medium in which the program has been stored or may be provided using other means such as a communication medium.

The foregoing program can also be said to be a program that causes the network device 10 to execute: a first step in which the QoS management unit 11 measures a QoS when user data transfer is performed between the UEs 41 and 42 via the UPFs 21 to 23 of the 5G core system device 20 which controls a network; a second step in which the PDU session management unit 12 acquires information of PDU sessions established for user data transfer between the UEs 41 and 42, from the SMF 25 of the 5G core system device 20; a third step in which the PDU session setting unit 13 determines whether or not to establish the new PDU sessions 201 and 202 based on the QoS; a fourth step in which the user-data transfer destination management unit 14 manages a group that is based on the new PDU sessions 201 and 202 and transfer destinations of user data in the new PDU sessions 201 and 202; and a fifth step in which the user-data transfer destination setting unit 15 sets, in the SMF 25, the transfer destinations of user data in the new PDU sessions 201 and 202.

Meanwhile, the processor 91 corresponds to, for example, a central processing unit (CPU), a processing device, a computing device, a microprocessor, a microcomputer, a digital signal processor (DSP), or the like. In addition, the memory 92 corresponds to, for example, a non-volatile or volatile semiconductor memory such as a random access memory (RAM), a read-only memory (ROM), a flash memory, an erasable programmable ROM (EPROM), or an electrically EPROM (EEPROM) (registered trademark); a magnetic disk, a flexible disk, an optical disk, a compact disc, a MiniDisc, a digital versatile disc (DVD), or the like.

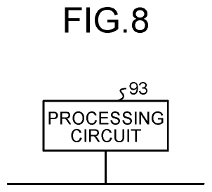

FIG. 8 is a diagram illustrating an example of a processing circuit 93 included in the network device 10 according to the present embodiment in the case where the processing circuit is formed by a dedicated hardware set. The processing circuitry 93 illustrated in FIG. 8 is, for example, a single circuit, a composite circuit, a programmed processor, a parallel programmed processor, an application specific integrated circuit (ASIC), a field programmable gate array (FPGA), or a combination thereof. The processing circuit may be implemented partially in a dedicated hardware set, and partially by software or firmware. As just described, the processing circuit can realize the above-described functions by dedicated hardware, software, firmware, or a combination thereof.

As described above, according to the present embodiment, when the PDU sessions 101 and 102 are established for making TSC between the UEs 41 and 42 and subjected to grouping, and then the network device 10 determines that the QoS cannot be satisfied, the device 10 additionally establishes the PDU sessions 201 and 202 for control communication between the lower-level UPFs 21 and 22 that are not connected to the TSN translator 24, on the basis of resource usage of the UPFs 21 and 22. The network device 10 sets, to the SMF 25, transfer destination addresses to allow the user data to be transferred between the lower-level UPFs 21 and 22 thus to enable the user data to be transferred by return between the lower-level UPFs 21 and 22. This enables the network device 10 to provide small-delay data transfer in TSC between the UEs 41 and 42 without a need to deploy a large number of TSN translators 24 in the 5G system 1.

Note that the present embodiment is based on the assumption that the UPFs 21 to 23 are connected to one and the same SMF 25, and the SMF 25 performs establishment of a PDU session, setting of a transfer destination address, and other operations, but the present disclosure is not limited thereto. Even in a case where the UPFs are associated with their respective different SMFs, and these different SMFs perform establishment of a PDU session, setting of a transfer destination address, and other operations, user data can also be transmitted and received without intervention of the UPF 23 connected to the TSN translator 24, in a similar manner to that described above, by the process in which the network device 10 performs management, setting, and the like of PDU sessions and of user-data transfer destinations for all the UPFs.

A network device according to the present disclosure has an advantageous effect that it can reduce delay in communication between wireless terminal devices while maintaining small the number of time sensitive network translators in user data transfer between wireless terminal devices in time sensitive communication.

The configurations described in the foregoing embodiment are merely examples. These configurations can each be combined with a other publicly known techniques, and embodiments can be combined with each other. Moreover, the configuration can be partially omitted and/or modified without departing from the scope of the present disclosure.

What is claimed is:

1. A network device comprising:
a quality-of-service management circuit to measure a quality of service when user data transfer is performed between wireless terminal devices via user transfer function circuits of a core system device that controls a network;
a session management circuit to acquire information of sessions from a session management function circuit of the core system device, the sessions having been established for user data transfer between the wireless terminal devices;
a session setting circuit to determine whether or not to establish new sessions, based on the quality of service;
a user-data transfer destination management circuit to manage a group that is based on the new sessions and transfer destinations of user data in the new sessions; and
a user-data transfer destination setting circuit to set, to the session management function circuit, the transfer destinations of user data in the new sessions.

2. The network device according to claim 1, wherein
when the quality of service is greater than an acceptable value predetermined, the session setting circuit instructs the session management function circuit to connect, to each other, user transfer function circuits that are not connected with a time sensitive network translator, among the user transfer function circuits, to establish the new sessions.

3. A control circuit for controlling a network device, the control circuit causing the network device to perform:
measuring a quality of service when user data transfer is performed between wireless terminal devices via user transfer function circuits of a core system device that controls a network;
acquiring information of sessions from a session management function circuit of the core system device, the sessions having been established for the user data transfer between the wireless terminal devices;
determining whether or not to establish new sessions, based on the quality of service;
managing a group that is based on the new sessions and transfer destinations of user data in the new sessions; and
setting, to the session management function circuit, the transfer destinations of user data in the new sessions.

4. A storage medium in which a program for controlling a network device has been stored, wherein
the program causes the network device to perform:
measuring a quality of service when user data transfer is performed between wireless terminal devices via user transfer function circuits of a core system device that controls a network;
acquiring information of sessions from a session management function circuit of the core system device, the sessions having been established for the user data transfer between the wireless terminal devices;
determining whether or not to establish new sessions, based on the quality of service;
managing a group that is based on the new sessions and transfer destinations of user data in the new sessions; and
setting, to the session management function circuit, the transfer destinations of user data in the new sessions.

5. A network configuration method in a network device, the network configuration method comprising:
a first step for a quality-of-service management circuit to measure a quality of service when user data transfer is performed between wireless terminal devices via user transfer function circuits of a core system device that controls a network;
a second step for a session management circuit to acquire information of sessions from a session management function circuit of the core system device, the sessions having been established for the user data transfer between the wireless terminal devices;
a third step for a session setting circuit to determine whether or not to establish new sessions, based on the quality of service;
a fourth step for a user-data transfer destination management circuit to manage a group that is based on the new sessions and transfer destinations of user data in the new sessions; and
a fifth step for a user-data transfer destination setting circuit to set, to the session management function circuit, the transfer destinations of user data in the new sessions.
